(19) United States
(12) Patent Application Publication
(10) Pub. No.: US 2009/0227461 A1
(43) Pub. Date: Sep. 10, 2009

(54) Preventing and/or Reducing "Lenticel Breakdown" Physiological Disorder in Apples by Applying Pre-Harvest Coatings

(76) Inventors: Roberto Carpentier, Newcastle, WA (US); Carolina Andrea Campo, Yakima, WA (US); Peter G. Sanderson, Wenatchee, WA (US)

Correspondence Address: MANN LAW GROUP, 1420 FIFTH AVENUE, SUITE 2200, SEATTLE, WA, 98101, US

(21) Appl. No.: 12/043,927

(22) Filed: Mar. 6, 2008

(51) Int. Cl. A01N 37/00; C11B 1/00; A01P 21/00

(52) U.S. Cl. 504/320; 554/8

(57) ABSTRACT

A preharvest coating for reducing the incidence of lenticel breakdown (LB) includes a plant-derived oil as the primary active ingredient. Preferably, the oil is mixed with a surfactant and further mixed with water to form an emulsion that is sprayed onto the apples during the growing season. Although a single application is effective, further effectiveness can be achieved by additional applications of the emulsion to the growing apples.

### FIELD OF THE INVENTION

This invention relates to the techniques of preventing or reducing the incidence and severity of “lenticel breakdown” in apples. In particular, the invention contemplates preventing or reducing “lenticel breakdown” through pre-harvest sprays of apple coating materials such as plant-derived oil emulsions.

### BACKGROUND OF THE INVENTION

Apple lenticel breakdown (“LB”) is a physiological disorder affecting many apple cultivars. The symptoms are brown and depressed pits (below lenticels) on the skin of the fruit. They appear mainly after harvest and the packing process, making the fruit unmarketable. This disorder has been associated to a dysfunction of the cuticle development during fruit growth. Therefore, even though the lenticel breakdown becomes evident post-harvest it is originated pre-harvest by many environmental and cultural factors not yet elucidated. This may account for why some orchard locations or blocks within an orchard are very prone to develop this physiological disorder while others appear completely resistant. Until now most of the research in this topic has focused on post-harvest practices that aggravate the incidence and severity of LB. In contrast, there is very limited information on pre-harvest factors that lead to LB.

### SUMMARY OF THE INVENTION

The invention is directed to the concept of treating apple fruit on the trees pre-harvest with coatings at one or more times prior or at fruit harvest.

Among the pre-harvest coatings that are effective in preventing or reducing lenticel breakdown in apples are formulations containing effective amounts of plant-derived oils. Preferably, the plant-derived oil is applied to the apples while they are still on the tree by spraying them with an emulsion of the oil in some form of liquid carrier.

In addition to plant-derived oils one or more emulsifiers can be included in the emulsions.

In addition to the plant-derived oil, one or more additives can be included in the water-based emulsion applied to the apples before harvest.

### DETAILED DESCRIPTION

Described herein are treatments, methods and formulations that have been found effective in reducing or preventing the incidence of lenticel breakdown (“LB”) when applied to apples during fruit growth and before harvest. In their broader aspects, the treatments, methods and formulations include the application of an active main formulary ingredient to the maturing fruit during the growing season and before harvest. The active main formulary ingredient is preferably combined with one or more surfactants and the resulting combination mixed with a carrier, such as water, before application to the fruit.

In addition to protecting against LB, the active main formulary ingredient can also provide protection against other adverse conditions, such as exposure to and/or injury from inclement weather (including wind, rain, extreme heat, dry air conditions), handling, transport; moisture loss; rapid and/or incorrect ripening; storage injury; pathogens and so forth. Preferably, the active main formulary ingredient is a plant-derived oil, lipid, carbohydrate (simple or complex), phospholipid or other film-forming compound of natural origin. It is believed that protection against LB is effected by covering and protecting the fruit lenticels against the above-described adverse conditions and environmental stimuli during fruit maturation. Examples of suitable active main formulary ingredients include, but are not limited to, Sunflower Oil, Olive Oil, Corn Oil, Sesame Oil, Jojoba Oil and Coconut Oil.

Although the active main formulary ingredient can be used by itself (i.e., 100% concentration) efficacy can be improved by combining the active main formulary ingredient with a surfactant. The surfactant can serve as an emulsifier, wetting agent, adjuvant, carrier, suspending agent, viscosity modifier or stabilizer. Preferably nonionic, anionic and amphiteric surfactants (excluding cationic species, which, at present are not approved for use on food products) can be used. Suitable surfactants include, but are not limited to, Alkanolamides; Alkanolamines; Alkylaryl Sulfonic Acid and Sulfonates; Alkylbenzenes; alkoxylated aryl phenols and alkylphenols; alkoxylated fatty acids, fatty esters, alcohols, and oils; Sulfonated amines and amides, Betaine Derivatives, Block Polymers, Diphenyl Sulfonate Derivatives, Alkoxylated amines and amides; Fatty esters; Fluorocarbon-based surfactants; Imidazoline Derivatives; Lanolin-based Derivatives; Lecithin and Lecithin Derivatives; Lignin and Lignin Derivatives; Succinic Anhydrides; Sulfosuccinates and Derivatives; Olefin Sulfonates; Phosphate Esters; Phosphorous Organic Derivatives; Polymeric (Polysaccharides, Acrylic Acid, Acrylamide); Protein-based Surfactants; Silicone-based Surfactants; Sorbitan Derivatives; Sucrose and Glucose esters and derivatives; Sulfates and Sulfonates of alkoxylated alkylphenols, Oils, fatty acids, alcohols, alkoxylated alcohols, dodecyl and tridecylbenzenes, Naphthalene and alkylnapthalene, petroleum; dodecyl and tridecylsulfonic acids.

Application of the main formulary ingredient and surfactant (if used) can be best effectuated by combining both with a liquid carrier to form an emulsion that is then applied to the fruit. Preferably, water is used as the carrier in an amount to achieve the desired concentrations. The range of effective concentrations is wide and can vary from between approximately 0.10% to 100% for the main formulary ingredient, and between approximately 0.01 to 99.9% for the surfactant, with the water carrier making up any difference.

The effectiveness of reducing or eliminating lenticel breakdown in apples through the pre-harvest application of various agents was tested. Examples of these tests are described below:

### EXAMPLE 1

### Application of a Single Plant-Derived Oil Formulation at Chelan, Wash

The trial was carried out on 10-yrs-old apple trees cultivar Imperial Gala on M26 rootstock. The treatment consisted in a single application of plant-derived oil (coconut oil) at 2.5% concentration. This was equivalent to 2.5 Gal in 100 gal of water. The solution was sprayed on homogeneous trees using a hand-gun sprayer until run-off one day before commercial harvest. Fruit from this treatment and an untreated control (6 replications per treatment=120 fruit) was harvested and stored separately in regular atmosphere (0° C., 90% relative humidity). After 180 days of storage fruit was run through a packing line and evaluated for LB presence after 48 hours at room temperature (20° C.). Table 1 shows the average incidence of LB per treatment, expressed as percentage of fruit without LB. The data were submitted to analysis of variance (P<0.05) and LSD as the mean separation test.

TABLE 1

| Treatment | % fruit with NO LB |
|---|---|
| Control | 17 a^{x} |
| Plant-derived oil, 2.5% | 35 b |

^{x}Different letters indicate statistical differences using LSD (95%)

### EXAMPLE 2

### Application of Single and Multiple Plant-Derived Oil Sprays Pre-Harvest

The trial was carried out on apple trees cultivar Imperial Gala and Gale Gala. The treatments consisted of single or triple applications of a plant-derived oil (coconut oil) at 2.5% concentration and an untreated control. The solution was sprayed on homogeneous trees using a hand-gun sprayer until run-off during the last week before harvest (single application) and weekly starting 3 weeks before harvest on the multiple application treatment. Fruit from all treatments (6 replicates per treatment=120 fruit) were harvested and stored separately in regular atmosphere (0° C., 90% relative humidity). After 90 and 180 days of storage fruit was run through a packing line and evaluated for LB presence after 48 hours at room temperature (20° C.). Table 2 and 3 shows the average incidence of LB per treatment, expressed as percentage of fruit with LB. The data were submitted to analysis of variance (P value indicated in the table) and LSD as the mean separation test.

TABLE 2
Gale Gala

| Treatment | Days in storage | # sprays | % fruit with LB |
|---|---|---|---|
| Control | 90 | 1 | 16.7 b^{x} |
| Plant-derived oil, 1.5% | 90 | 1 | 12.5 b |
| Control | 180 | 1 | 19.2 b |
| Plant-derived oil, 2.5% | 180 | 1 | 14.2 b |
| Control | 90 | 3 | 16.7 b |
| Plant-derived oil, 2.5% | 90 | 3 | 5.0 a |
| Control | 180 | 3 | 19.2 b |
| Plant-derived oil, 2.5% | 180 | 3 | 10.8 a |

^{x}Different letters indicate statistical differences using LSD (95%)

TABLE 3
Imperial Gala

| | Days in | # | % fruit |
|---|---|---|---|
| Treatment | storage | sprays | with LB |
| Control | 90 | 1 | 10.6 a^{x} |
| Plant-derived oil, 2.5% | 90 | 1 | 6.2 b |

^{x}Different letters indicate statistical differences using LSD (95%)

In each of the above examples, emulsions were prepared by combining the various agents in a liquid carrier. The liquid carrier consisted essentially of water. The liquid emulsion was mixed and maintained at approximately 28° C. and was applied to apple trees by means of spraying the trees with the diluted emulsion.

Based on the foregoing, it was demonstrated that applying a spray or coating containing a plant-derived oil component to apples before harvest was effective in reducing or preventing lenticel breakdown in the apple fruit and that the beneficial effects of the treatment extended into the post-harvest period.

A preferred formulation found effective for reducing the incidence of LB is as follows:

| | |
|---|---|
| Triglycerides with C16 and C18 fatty acids | 6.00% |
| C16 and C18 fatty acid esters | 6.00% |
| Emulsifiers | 1.00% |
| Water | 86.50% |
| Alkyl dimethyl benzyl ammonium chloride | 0.5% |

Although this formulation is preferred, it will be appreciated that the precise combinations, concentration, etc. are not critical and that others can be advantageously used. It will also be appreciated that the formulation can be applied to the fruit prior to harvest and during the growing season by various means, such as spraying, fogging, etc.

In a practical application, the main formulary ingredient and surfactant, if any, are combined to form a concentrate. Before actual use, the concentrate is then mixed with the water to form the final emulsion or field solution that is then applied to the apples. Preferably, the proportions are selected so that the concentration of the main formulary ingredient in the final field solution is in the range of 0.5% to 6%, with a preferred concentration of 2.5%.

It will be appreciated that, while particular concentrations, temperatures, velocities, times, etc. have been described, other parameters can be advantageously selected without deviating from the invention in its broader aspects.

What is claimed is:

1. A coating for preharvest application to apples to reduce the incidence of lenticel breakdown, said coating comprising a plant-derived oil and a carrier for facilitating the distribution of the plant-derived oil over the surface of the apple in a substantially continuous layer.

2. A coating as defined in claim 1 wherein said plant-derived oil is selected from the group consisting of Sunflower Oil, Olive Oil, Corn Oil, Sesame Oil, Jojoba Oil and Coconut Oil.

3. A coating as defined in claim 2 wherein said coating further includes a surfactant.

4. A coating as defined in claim 3 wherein said surfactant is selected from the group consisting of Alkanolamides; Alkanolamines; Alkylaryl Sulfonic Acid and Sulfonates; Alkylbenzenes; alkoxylated aryl phenols and alkylphenols; alkoxylated fatty acids, fatty esters, alcohols, and oils; Sulfonated amines and amides, Betaine Derivatives, Block Polymers, Diphenyl Sulfonate Derivatives, Alkoxylated amines and amides; Fatty esters; Fluorocarbon-based surfactants; Imidazoline Derivatives; Lanolin-based Derivatives; Lecithin and Lecithin Derivatives; Lignin and Lignin Derivatives; Succinic Anhydrides; Sulfosuccinates and Derivatives; Olefin Sulfonates; Phosphate Esters; Phosphorous Organic Derivatives; Polymeric (Polysaccharides, Acrylic Acid, Acrylamide); Protein-based Surfactants; Silicone-based Surfactants; Sorbitan Derivatives; Sucrose and Glucose esters and derivatives; Sulfates and Sulfonates of alkoxylated alkylphenols, Oils, fatty acids, alcohols, alkoxylated alcohols, dodecyl and tridecylbenzenes, Naphthalene and alkylnapthalene, petroleum; dodecyl and tridecylsulfonic acids.

5. A coating as defined in claim 1 wherein said plant-derived oil and surfactant are mixed with water to form an emulsion prior to application to the apples.

6. A coating as defined in claim 5 wherein the concentration of the plant-derived oil ranges from approximately 0.10% to substantially 100%.

7. A coating as defined in claim 5 wherein the concentration of the surfactant ranges from approximately 0.01% to 99.9%.

8. A coating as defined in claim 5 wherein the plant-derived oil is coconut oil.

9. A method of treating apples to reduce the incidence of lenticel breakdown, said method comprising the steps of:
selecting a main formulary ingredient from the group consisting of plant-derived oils, lipids, carbohydrates (simple or complex), phospholipids or other film-forming compound of natural origin;
mixing the main formulary ingredient with a carrier to form a liquid mixture; and
applying the mixture to the apples before harvest to form a coating of the main formulary ingredient on the apples.

10. A method as described in claim 9 comprising the further step of adding a surfactant to the main formulary ingredient and carrier to form part of the mixture.

11. A method as described in claim 10 wherein the surfactant is selected from the group consisting of Alkanolamides; Alkanolamines; Alkylaryl Sulfonic Acid and Sulfonates; Alkylbenzenes; alkoxylated aryl phenols and alkylphenols; alkoxylated fatty acids, fatty esters, alcohols, and oils; Sulfonated amines and amides, Betaine Derivatives, Block Polymers, Diphenyl Sulfonate Derivatives, Alkoxylated amines and amides; Fatty esters; Fluorocarbon-based surfactants; Imidazoline Derivatives; Lanolin-based Derivatives; Lecithin and Lecithin Derivatives; Lignin and Lignin Derivatives; Succinic Anhydrides; Sulfosuccinates and Derivatives; Olefin Sulfonates; Phosphate Esters; Phosphorous Organic Derivatives; Polymeric (Polysaccharides, Acrylic Acid, Acrylamide); Protein-based Surfactants; Silicone-based Surfactants; Sorbitan Derivatives; Sucrose and Glucose esters and derivatives; Sulfates and Sulfonates of alkoxylated alkylphenols, Oils, fatty acids, alcohols, alkoxylated alcohols, dodecyl and tridecylbenzenes, Naphthalene and alkylnapthalene, petroleum; dodecyl and tridecylsulfonic acids.

12. A method as defined in claim 11 wherein the carrier is water.

13. A method as defined in claim 11 wherein the concentration of the main formulary ingredient ranges from approximately 0.10% to substantially 100%.

14. A method as defined in claim 11 wherein the concentration of the surfactant ranges from approximately 0.01% to 99.9%.

15. A method as defined in claim 11 wherein the main formulary ingredient is selected from the group consisting of Sunflower Oil, Olive Oil, Corn Oil, Sesame Oil, Jojoba Oil and Coconut Oil. %.

16. A method as defined in claim 9 wherein the concentration of the main formulary ingredient in the mixture is in the range of approximately 0.5% to 6%.

17. A method as defined in claim 16 wherein the concentration of the main formulary ingredient in the mixture is approximately 2.5%.

18. A method as defined in claim 11 wherein the mixture is applied to the apples by means of spraying.

19. A method as defined in claim 17 further comprising the step of applying the mixture to the apples in a plurality of applications.
